(19) United States
(12) Patent Application Publication
(10) Pub. No.: US 2019/0393491 A1
(43) Pub. Date: Dec. 26, 2019

(54) BATTERY

(71) Applicants: Volkswagen Aktiengesellschaft, Wolfsburg (DE); Audi Aktiengesellschaft, Ingolstadt (DE); Dr. Ing. h.c. F. Porsche Aktiengesellschaft, Weissach (DE)

(72) Inventors: Mirko Herrmann, Mountain View, CA (US); Angela Speidel, Mountain View, CA (US)

(73) Assignees: Volkswagen Aktiengesellschaft, Wolfsburg (DE); Audi Aktiengesellschaft, Ingolstadt (DE); Dr. Ing. h.c. F. Porsche AG, Weissach (DE)

(21) Appl. No.: 16/447,122

(22) Filed: Jun. 20, 2019

(30) Foreign Application Priority Data
Jun. 20, 2018 (DE) 10 2018 114 804.6

(51) Int. Cl. H01M 4/36; H01M 10/0525; H01M 4/04; H01M 4/525; H01M 4/62

(52) U.S. Cl. CPC H01M 4/366; H01M 10/0525; H01M 4/049; H01M 2004/021; H01M 4/625; H01M 4/0404; H01M 4/045; H01M 4/525

(57) ABSTRACT

The invention relates to a battery, namely a lithium-ion battery, with an electrode layer and a current conductor, wherein the electrode layer has a plurality of auxiliary channels in an active material. The battery is improved in that the auxiliary channels are formed both at a cathode and at an anode.

### FIELD OF THE INVENTION

The invention relates to a battery. The invention further relates to methods for manufacturing such a battery.

### BACKGROUND OF THE INVENTION

A battery has one or more cells. In particular, a cell has an anode, a cathode, a separator, and an electrolyte. The electrode consists of an active material and an arrester. The term “active materials” refers to materials in the electrodes in which the chemical material change processes, namely the storing and releasing of energy, take place. The C rate describes the charging or discharging current in amps normalized to the nominal capacity. Nominal capacity is the amount of electricity stored in a fully charged cell or battery that can be removed during discharging under defined conditions.

In a conventional battery cell, the active materials have a weight fraction of about 45 to 50%. The remaining weight fraction is constituted by the housing, the electrolyte, the arresters for the anode and the cathode, and the separator. Unfortunately, these components are indispensable for the battery, but it is desirable to improve the ratio between active and non-active materials in favor of the active materials. This can be achieved by increasing the areal capacity. The unit for areal capacity is mAh/cm². A common automotive battery cell has a areal capacity of from 2.5 to 4 mAh/cm². For instance, with normal pressing of the electrode layer, an electrode thickness of about 50 micrometers has an areal capacity of 3.5 mAh/cm². An increase in the thickness of the electrode layer to about 100 micrometers would theoretically increase the areal capacity to 7 mAh/cm². However, problems arise due to the longer diffusion paths and local variations in lithium ion concentration. The current-carrying capacity drops sharply, and the full 7 mAh/cm² can then only be achieved at C rates of less than 0.1 to 0.2 C. For electronic devices that do not require high C rates, peak currents, or high charge rates, such a coating would be sufficient. Such batteries can be used, for example, for emergency exit lighting or mobile mp3 players. In an automotive application, problems arise due to high charge/discharge rates and the high peak currents resulting from acceleration and recuperation. With a current-carrying capacity of 1 C, the full capacity of the surface is no longer exploited uniformly, which means that the areas closer to the separator are subjected to greater stress than the areas in the vicinity of the current conductor. In the case of a fast charge below 20 minutes, this means a C rate of at least 3 C.

A battery having an anode with a cathode and with a separator in the vicinity of the anode and the cathode is known from EP 2 749 396 A1. The cathode has interdigitated strips of active cathode materials, the interdigitated strips of material being arranged as a plurality of layers of a first material and a second material. These materials each contain lithium, with the first material having a lower lithium concentration than the second material. The first material forms pore channels. Current arresters are arranged on the outside on the anode and cathode, respectively. The anode can comprise interdigitated strips of material, in which case one of the materials forms pore channels. The pore channels play an important role as a sink or source for facilitating the movement of lithium ions. These pore channels make shorter lithium ion paths possible. This makes it possible to use thicker electrodes. A method for manufacturing the battery is also described in which a first active material is mixed with a solvent to produce a first electrode active material. A second active material is mixed with a solvent to produce a second electrode active material. The first electrode active material and the second electrode active material are coextruded onto a surface as interdigitated strips. The coextrusion is performed by means of a print head that enables different fluids to flow alternately to a point without the two fluids being mixed. The solvent is removed from the first and second electrode active materials to produce a battery cathode. A separator is placed on the cathode and an anode on the separator to form the battery. A conductive agent such as carbon can be used during mixing. As a result of the extrusion, electrodes of different densities are produced in strand form. The cathodes produced in this manner have greater performance and higher volumetric energy density. This design has the disadvantage of low performance, because the ratio of the surface area and volume of active materials to inactive materials is not optimal. Furthermore, the manufacturing process is complicated and slow.

A solid-state battery with a coating for improving surface ion diffusion and a method for manufacturing these solid-state batteries is known from EP 2 814 091 A1. The cathode and/or the anode have a battery material that has pores. The inner surface of the pores is coated with a coating that enhances surface diffusion. The porous structure of the active electrode materials and the coating of the pores with solid electrolyte layer are intended to promote diffusion and thus improve the battery.

Category-defining WO 2017/023900 A1 discloses a battery with a metallic lithium anode and a method for manufacturing the battery. A substrate having a first surface is formed, with the first surface having a plurality of pores. The pores form auxiliary channels and contain lithium metal. The method includes the introduction of lithium metal into at least a portion of the pores. An electrolyte is formed that is arranged between the first surface of the substrate and a cathode. The electrolyte is configured so as to reversibly transport lithium ions through the diffusion between the substrate and the cathode. In some embodiments, the substrate serves as both an anode and an electrically conductive current collector. The battery thus has a microporous current collector with lithium metal incorporated in the pores. The microporous substrate is a metal such as copper or nickel. The metal is electrically and chemically stable with lithium. Alternatively, the electrically conductive material can be a conductive polymer or comprise carbon nanotubes. Anode materials such as graphite or lithium are dispensed with. The microporous substrate can thus serve as an anode with a reservoir of lithium metal and as a current collector. The microporous substrate can improve the exchange of lithium metal near the anode/collector interface. In other words, the porous substrate structure can increase the volume in which lithium can be incorporated into the current collector. One possible outcome is that the battery performance should be improved over the life of the battery due to higher lithium diffusion rates. Therefore, this lithium-ion battery should have higher efficiency, higher power density, and/or a better cycle life. The pores within the substrate can have a spherical, hemispherical, cylindrical, conical, random, or pseudorandom shape. The pores can be spaced apart at regular or irregular intervals. The pores may be arranged in a regular configuration, such as a hexagonal, square, linear, or other group arrangement. For example, a plurality of spherical pores can be disposed in a square mesh having a center-to-center distance of approximately 100 micrometers. The square mesh can be repeated from a plurality of stacked pore layers within the microporous substrate. As a manufacturing method, it is specified that, if the substrate material is copper or nickel, it is oxidized with a heated oxygen alloy. After oxidation, the pores in the substrate material can be etched by wet or dry etching. As an alternative manufacturing process, the microporous structure can be produced by means of additive material deposition. For example, the microporous structure can be formed using a 3D printer, galvanization, and/or electroplating, patterned metal deposition, or other material deposition techniques. This battery has the disadvantage that a metallic lithium anode is consumed over the course of the cycles as lithium is continuously dissolved and deposited.

### SUMMARY OF THE INVENTION

It is, therefore, the object of the invention to improve the category-defining type battery and the category-defining method for manufacturing the battery.

This object underlying the invention is now achieved by a battery with the features of the claims and by a method with the features of the claims.

According to the invention, the auxiliary channels are formed both in an electrode layer of the cathode and in an electrode layer of the anode. The auxiliary channels form a matrix and do not have a strand-like structure, but rather are constructed point by point in the electrode layer. The surface and volume ratio of the active materials to non-active materials with possibly greater electrode thicknesses is improved by providing the auxiliary channels for both the anode and the cathode. As a result, greater electrode layer thicknesses can be formed with simultaneously high C rates.

The cathode can have graphite as the active material. The anode can have a lithium compound as the active material. The current conductors can be made of copper and aluminum. The separator is formed by a polymer structure. The salts LiPF₆, LiBF₄, or LiBOB dissolved in anhydrous aprotic solvents such as ethylene carbonate, propylene carbonate, dimethyl carbonate, diethylene carbonate of 1,2-dimethoxyethane or polymers of PVDF or PVDF-HFP in a lithium polymer battery or Li₃PO₄N can be used as the electrolyte.

A matrix with the auxiliary channels is applied to the current conductor for both the anode and cathode before the actual coating with active material. The auxiliary channels are built up point by point, which has the advantage over a stranded structure that the performance of the battery is improved, since the surface and volume ratio of active materials to non-active materials is improved. This application can be done by printing, spraying, doctoring, screen printing, or sputtering. The auxiliary channels are aligned perpendicular to the current conductor. The auxiliary channels can be knob-like, conical, tubular, cylindrical, cuboid-shaped or rectangular, or pyramidal. It is also conceivable for the auxiliary channels to have a honeycomb shape. While such a honeycomb structure is conceivable, a tubular structure of the auxiliary channels offers the best ratio of ambient active material to the surface of the auxiliary channels.

The auxiliary channels can be produced quickly and easily by means of a doctor-roll method, a gel with or without conductive additives being applied to the current conductor using the doctor-roll method.

The auxiliary channels can also be produced quickly and easily by physically perforating and/or embossing an electrode layer.

The auxiliary channels can be produced quickly and easily by injecting a liquid or a gelled liquid into a substantially liquid electrode film.

The auxiliary channels can have a length of between 1 and 100% of the electrode film thickness. The auxiliary channels preferably have a diameter of from 0.5 to 5000 μm, preferably between 5 and 2000 μm, more preferably between 10 and 1000 μm, and especially preferably between 20 and 500 μm. The auxiliary channels can be formed by an open structure without filling.

Alternatively, the auxiliary channels can be filled with auxiliary substances through a closed structure. Auxiliary substances can be conductive additives such as conductive carbon black or metallic particles. The auxiliary substances can include active materials of a different density, composition, specification, and electrochemical or physical properties. It is possible for all of the auxiliary channels to have active materials with other specifications, or only a portion thereof. It is possible for all of the auxiliary channels to be provided with or without filling, or only a portion thereof. It is also possible for all of the auxiliary channels to be provided and/or filled with a conductive additive, or only a portion thereof. The electrode layer can have auxiliary channels with active material, conductive additives, and auxiliary channels without filling. More than 50% of the auxiliary channels can be filled. More than 50% of the auxiliary channels can have a conductive additive.

A conventional lithium-ion battery has a densification of from about 24 to 30%. If a 30% residual porosity of the electrode layer is achieved by means of vertically aligned auxiliary channels, then high C rates can be achieved with thick electrode layers in a simple manner.

For the consideration that follows, it is assumed that the usable residual porosity for transport is 15% instead of 30% and that only the last 30 to 40 μm have a higher porosity toward the separator. The surface load is to be about 8 mAh/cm². This results in an electrode thickness of about 100 μm. In the range of 50 to 70% of the electrode layer—with the current conductor being the starting point here—a massive increase in the lithium ion concentration occurs, which leads to a decrease in the diffusion rate of lithium ions. A high lithium ion concentration now has to squeeze through suitable transport routes, which also results in local surges. In the range from 70 to 100%, with 100% being present at the separator, the lithium ions can be delivered to the electrolyte bulk phase with much less resistance. The risk here is that, at a higher C-rate, the regions of the separator are subjected to greater loads and age faster. If the electrode layer is now crossed with a matrix of auxiliary channels, then no accumulation of lithium ions occurs in the range from 50 to 70%. For example, 10% of the electrode layer can be composed of auxiliary channels. In addition, the lithium concentration profile over the electrode layer is substantially lower despite the increase in the electrode thickness to about 110 μm with the same surface load of 8 mAh/cm². Model calculations have shown that an approximately 110 μm-thick electrode with 8 mAh/cm² and a load of 3 C has the same maximum lithium concentration electrode layer profile as a conventional cell at 50 μm, 3.5 mAh/cm², and 11 C.

There are now a variety of ways to advantageously configure and develop the battery and method according to the invention. Reference is made firstly to the claims that are subordinated to the independent claim.

### BRIEF DESCRIPTION OF THE DRAWINGS

In the following, preferred embodiments of the invention are explained in more detail with reference to the drawings and the associated description. In the drawing:

FIG. 1 shows a schematic representation of a portion of a battery, namely an electrode layer, a separator, and a current conductor,

FIG. 2 shows a schematic representation of an arrangement for manufacturing a corresponding electrode layer on the current conductor,

FIG. 3 shows a schematic representation of a current conductor with two differently designed electrode layers, namely an electrode layer with auxiliary channels without filling and an electrode layer with auxiliary channels with filling, and

FIG. 4 shows a schematic representation of differently configured forms of auxiliary channels.

### DETAILED DESCRIPTION OF THE INVENTION

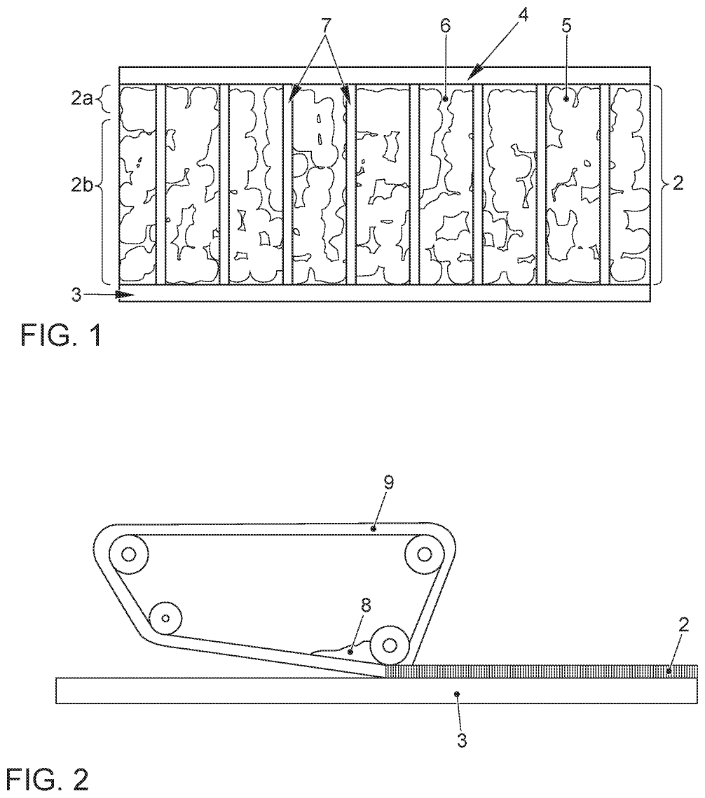

FIG. 1 shows a portion of a battery 1. The battery 1 has an electrode layer 2, a current conductor 3, and a separator 4. The electrode layer 2 has an active material 5, the active material 5 having pores 6. The pores 6 can form channels and chambers. The active material 5 is arranged between the separator 6 and the current conductor 3. The current collector 3 and the separator 4 extend parallel to one another. The electrode layer 2 preferably has a substantially constant layer thickness. In particular, the electrode layer thickness can be greater than 50 μm, more particularly greater than 80 μm, and preferably 100 μm. Preferably, the electrode layer thickness is in the range between 80 and 120 μm; for example, the electrode layer thickness can be 100 or 110 μm.

The electrode layer 2 is provided with auxiliary channels 7. The auxiliary channels 7, 7a to 7e are constructed point by point in the active material 5. The auxiliary channels 7 preferably extend between 1 and 100% of the electrode layer thickness. In the illustrated embodiment, the auxiliary channels 7 extend over 100% of the electrode layer thickness. In particular, the auxiliary channels 7 extend over at least 50% of the electrode layer thickness.

The arrangement shown in FIG. 1 can form either an anode or a cathode. Both the anode and the cathode have the corresponding auxiliary channels 7. The auxiliary channels 7 extend perpendicularly between the electrode layer 2 and the separator 4.

The electrode consists of the active material and the arrester. An electrolyte that is instantiated by a liquid or gel-like medium that ensures the transport of the ions between the anode and the cathode is not further specified here.

FIG. 2 shows a preferred manufacturing method. In order to achieve continuous formation of the auxiliary channels 7, a gel 8 with or without conductive additives (not shown) can be applied to the current collector 3 by means of a doctor-roll method or a printing method. FIG. 2 shows a corresponding doctor roll 9. Alternatively, the matrix with the auxiliary channels 7 can be applied in a printing process. In particular, the auxiliary channels 7 can be printed. Today's printers with gel inks already create much higher resolutions than are needed for the formation of the auxiliary channels 7. Alternatively, the auxiliary channels 7 can be applied directly to the bare current collector 3. Alternatively, the auxiliary channels 7 can be subsequently inserted into the electrode layer 2. This can be done by injecting a liquid or gelled liquid into the liquid electrode film. It is possible for the injected liquid or the gelled liquid to have no additives or additives. A third way is to physically perforate a solid but soft electrode film with a needle roller or calender with an embossing roller, for example.

All methods ultimately produce a tubular vertical auxiliary channel structure in the electrode layer 2. This auxiliary channel structure can either have no filling or a filling of additives, such as conductive carbon black or low-density active material.

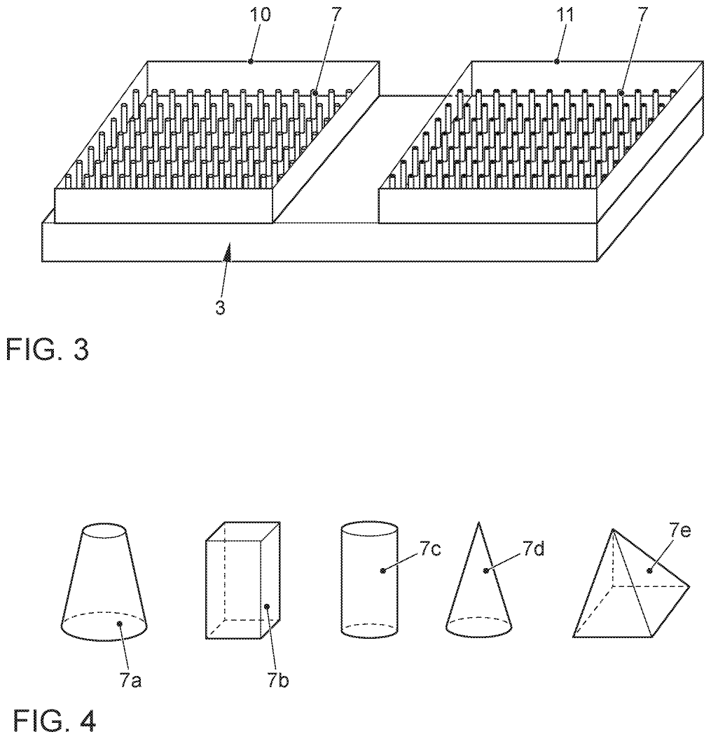

FIG. 3 shows an electrode layer 10 with auxiliary channels without filling and an electrode layer 11 with auxiliary channels with filling. These are each formed on a current collector 3.

FIG. 4 shows auxiliary channels of various shapes. Conical auxiliary channels 7a and cuboid auxiliary channels 7b, cylindrical auxiliary channels 7c, conical auxiliary channels 7d, and pyramidal auxiliary channels 7e are shown. The auxiliary channels can have a diameter of from 0.5 to 5000 μm, preferably between 5 and 2000 μm, more preferably between 10 and 1000 μm, and most preferably between 20 and 500 μm. Additives such as conductive additives such as conductive carbon black or metallic particles can be used. The auxiliary substances can include active materials of a different densification, composition, specification, and electrochemical or physical properties.

### LIST OF REFERENCE SYMBOLS

1 battery
2 electrode layer
3 current conductor
4 separator
5 active material
6 pores
7 auxiliary channel
7a conical auxiliary channel
7b rectangular auxiliary channel
7c cylindrical auxiliary channel
7d cone-shaped auxiliary channel
7e pyramidal auxiliary channel
8 gel
9 doctor roll
10 electrode layer with auxiliary channels without filling
11 electrode layer with auxiliary channels with filling

1. A battery, comprising:
an electrode layer, and
a current conductor,
wherein the electrode layer has a plurality of auxiliary channels in an active material,
wherein the auxiliary channels are formed both at a cathode and at an anode.

2. The battery as set forth in claim 1, wherein the auxiliary channels have a diameter of from 0.5 to 5000 μm.

3. The battery as set forth in claim 2, wherein the auxiliary channels have a diameter of between 5 and 2000 μm.

4. The battery as set forth in claim 3, wherein the auxiliary channels have a diameter of between 10 and 1000 μm.

5. The battery as set forth in claim 4, wherein the auxiliary channels have a diameter preferably between 20 and 500 μm.

6. The battery as set forth in claim 1, wherein the auxiliary channels are constructed point by point in the active material.

7. The battery as set forth in claim 1, wherein the auxiliary channels have an open structure without filling.

8. The battery as set forth in claim 1, wherein the auxiliary channels have a closed structure with auxiliary substances.

9. The battery as set forth in claim 1, wherein the auxiliary substances have conductive additives.

10. The battery as set forth in claim 1, wherein the auxiliary substances have an active material with a different densification, a different composition, a different specific specification, and/or different electrochemical and/or other physical properties than the active material of the other electrode layer.

11. The battery as set forth in claim 1, wherein more than 50% of the auxiliary channels are provided with a filling.

12. The battery as set forth in claim 1, any one of the preceding more than 50% of the auxiliary channels have a conductive additive.

13. The battery as set forth in claim 1, wherein the battery is a lithium-ion battery.

14. A method for manufacturing a battery as set forth in claim 1, any one of the preceding the auxiliary channels is produced by a doctor-roll method, a gel with or without conductive additives being applied to the current collector using the doctor-roll method.

15. The method for manufacturing a battery as set forth in claim 1, wherein the auxiliary channels are produced by physically perforating and/or embossing an electrode layer.

16. The method for manufacturing a battery as set forth in claim 1, wherein the auxiliary channels are produced by injecting a liquid or a gelled liquid into a substantially liquid electrode film.
